(19) United States
(12) Patent Application Publication
(10) Pub. No.: US 2015/0107131 A1
(43) Pub. Date: Apr. 23, 2015

(54) Drying System and Method of Use Thereof

(71) Applicant: Bruce A. Barnes, Ftichburg, MA (US)

(72) Inventor: Bruce A. Barnes, Ftichburg, MA (US)

(21) Appl. No.: 14/331,250

(22) Filed: Jul. 15, 2014

Related U.S. Application Data
(60) Provisional application No. 61/892,838, filed on Oct. 18, 2013.

(51) Int. Cl. F26B 21/00; F26B 3/02

(52) U.S. Cl. CPC F26B 21/004; F26B 3/02
USPC 34/487; 34/103

(57) ABSTRACT

A drying system and method with a container such as a bucket, a small electrical fan mounted to the container such that when it is powered it draws air into the container, and a plurality of tubes coupled to the container such that they each fluidly communicate with the interior of the container. The tubes are constructed and arranged to be placed into items of clothing such as footwear and gloves, so that when the fan is energized air will be directed through one or more of the tubes into such item of clothing, to dry the item.

### CROSS-REFERENCE TO RELATED APPLICATION

This application claims priority of Provisional Patent Application Ser. No. 61/892,838 filed on Oct. 18, 2013.

### BACKGROUND

Outdoor activities such as fishing, skiing, sledding and hunting can be performed in wet and sometimes cold conditions. Boots and other footwear are often worn during such activities. Gloves are also sometimes worn. These clothing items often become wet from the weather conditions or sweat. They need to be dried thoroughly before they are reused or else they are uncomfortable and can lead to growth of mold and the like, and cause unpleasant odors. Accordingly, it is desirable to provide a means of effectively drying footwear gloves and other items.

### SUMMARY

The subject drying system is a portable, easy to use system that plugs into any wall outlet and effectively dries footwear, gloves and other items. The system includes a container such as a bucket. The container carries a fan that circulates air into the container. The container is closed except for one or more tubes that are fluidly coupled to the interior of the container. The tubes are flexible. A tube can be directed into or onto an item that needs to be dried. For example, a tube can be placed into an item of footwear, or a glove. The tube is preferably but not necessarily small enough to be pushed up close to the toe of a footwear item so that air circulates throughout the entire inside of the item. The electrical plug is engaged in an outlet and the fan comes on. The fan pushes air through the bucket and the tube or tubes that are in use. Typically air flow is at a relatively low flow rate and at room temperature. However, the flow rate may be greater or less, and there may be a provision to heat the air (such as with a heating coil in the container that is also powered by the electricity). The system can be left on for as long as necessary to dry the articles. When footwear and articles of clothing are being dried, the system can typically be run overnight so that the items arc dry and ready to be used the next morning. For skiers and hunters this is particularly advantageous and appealing.

This disclosure features a drying system comprising a container, a small electrical fan mounted to the container such that when it is powered it draws air into the container, and a plurality of tubes coupled to the container such that they each fluidly communicate with the interior of the container. The tubes are constructed and arranged to be placed into items of clothing such as footwear and gloves so that when the fan is energized air will be directed through one or more of the tubes into such item of clothing, to dry the item. The container can be a bucket with a lid, and there can be a number of corrugated extendable and retractable tubes mounted to the lid and projecting upwardly therefrom.

The container may be substantially empty. The container may have a sidewall with an opening therethrough, and the fan may be mounted to the sidewall in the opening. The tubes may be collapsible. The tubes may be corrugated. The drying system may further comprise removable caps that are constructed and arranged to be selectively applied over the ends of tubes.

Also featured is a drying system, comprising an empty bucket with a lid, the bucket having a sidewall with an opening therethrough, a small electrical fan mounted to the container sidewall in the opening, such that when the fan is powered it draws air into the container, a plurality of corrugated, extendable and retractable tubes coupled to the lid such that they each fluidly communicate with the interior of the container, and a plurality of removable caps that are constructed and arranged to be selectively applied over the ends of tubes. The tubes are constructed and arranged to be placed into items of clothing such as footwear and gloves, so that when the fan is energized air will be directed through one or more of the tubes into such item of clothing, to dry the item.

Also featured is a method of drying articles of clothing, comprising providing an empty bucket with a lid, the bucket having a sidewall with an opening therethrough, and a small electrical fan mounted to the container sidewall in the opening, such that when the fan is powered it draws air into the container, and a plurality of corrugated, extendable and retractable tubes coupled to the lid such that they each fluidly communicate with the interior of the container, and a plurality of removable caps that are constructed and arranged to be selectively applied over the ends of tubes; selecting a number of tubes equal to the number of articles of clothing to be dried; removing the caps from the selected tubes; extending the selected tubes from the container and placing the open end of each tube into or near an article of clothing; and then energizing the fan so as to force air through the tubes and into or on the articles of clothing, until the articles of clothing are sufficiently dried.

### BRIEF DESCRIPTION OF THE DRAWINGS

One example of the subject drying system is shown in the drawings, in which:

FIG. 1 is a side view of the system stowed and ready for use.

FIG. 2 shows the system in use drying a single item of footwear.

FIG. 3 is a top view showing that a number of separate tubes can be included so that multiple items can be dried at once.

### DETAILED DESCRIPTION

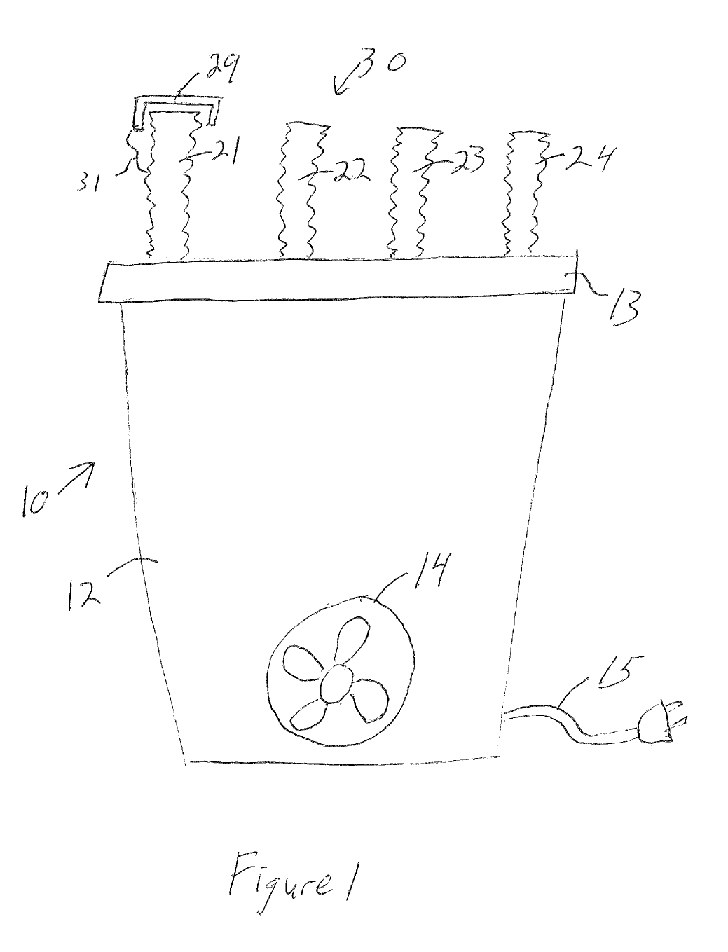

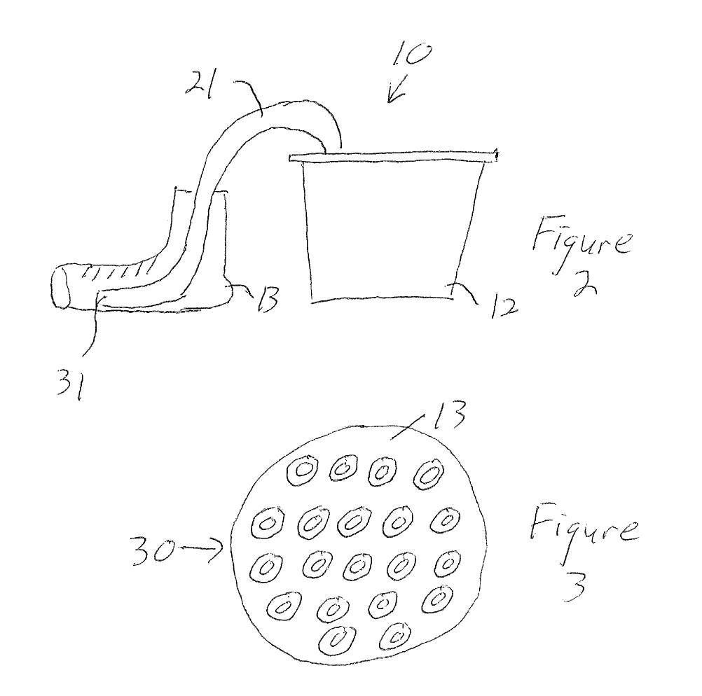

Drying system 10 comprises an empty (or at least sufficiently empty to promote the necessary airflow) bucket 12 with an opening created in the side to which is mounted a fan 14. The fan can be a small pancake fan such as the type used in personal computers, but other types of fans can be used. When the fan is powered through cord 15 the fan draws air into the bucket. The top of the bucket 13 is adapted to carry one or more tubes. Each tube fluidly communicates with the inside of the bucket. In this example, tube set 30 includes approximately twenty tubes, with only tubes 21-24 shown in FIG. 1, and only a single tube 21 with open end 31 inside of boot B shown in FIG. 2, for the purposes of clarity only. Each of these tubes can be a collapsible corrugated plastic tube that is coupled to the top 13 of bucket 12, and can stretch up to perhaps 36 inches in length and be collapsed such that it stands up in the position shown in FIG. 1, to provide an easy to store system. The system may include removable caps that can be used to close off the ends of the tubes, such as cap 29. The caps can be used to close tubes that are not in use so that air is directed only through the tubes that are in use drying articles. The caps may be tethered to the tube so they are less likely to be lost when removed from the end of the tube; see tether 31.

The container does not need to be a bucket as long as it is closed or substantially closed with an air inlet and outlets through one or more hoses or tubes. The hoses need not be corrugated. The hoses do not need to be capped. When capped, the caps can be coupled to the hose so that they are less likely to be lost when removed from the open end of the hose. Other options and features will occur based on this description, and are within the scope of the invention. For example, there may be an electrically-operated air heater in the bucket to warm the air so it is more effective in drying.

Also featured herein is a method of drying articles of clothing, using the apparatus described above. First, there is provided an empty bucket with a lid, the bucket having a sidewall with an opening therethrough, and a small electrical fan mounted to the container sidewall in the opening, such that when the fan is powered it draws air into the container, and a plurality of corrugated, extendable and retractable tubes coupled to the lid such that they each fluidly communicate with the interior of the container, and a plurality of removable caps that are constructed and arranged to be selectively applied over the ends of tubes. Next, there is a selection of a number of tubes equal to the number of articles of clothing to be dried. Next there is a removal of the caps from the selected tubes. Next there is an extending of the selected tubes from the container, and placing the open end of each tube into or near an article of clothing. And then there is an energizing of the fan so as to force air through the tubes and into or on the articles of clothing, until the articles of clothing are sufficiently dried.

What is claimed is:

1. A drying system, comprising:
a container;
a small electrical fan mounted to the container such that when it is powered it draws air into the container; and
a plurality of tubes coupled to the container such that they each fluidly communicate with the interior of the container;
wherein the tubes are constructed and arranged to be placed into items of clothing such as footwear and gloves, so that when the fan is energized air will be directed through one or more of the tubes into such item of clothing, to dry the item.

2. The drying system of claim 1 comprising a bucket with a lid, with the plurality of corrugated extendable and retractable tubes mounted to the lid and projecting upwardly therefrom.

3. The drying system of claim 1 wherein the container is substantially empty.

4. The drying system of claim 1 wherein the container has a sidewall with an opening therethrough, and the fan is mounted to the sidewall in the opening.

5. The drying system of claim 1 wherein the tubes are collapsible.

6. The drying system of claim 5 wherein the tubes are corrugated.

7. The drying system of claim 1 further comprising removable caps that are constructed and arranged to be selectively applied over the ends of tubes.

8. A drying system, comprising:
an empty bucket with a lid, the bucket having a sidewall with an opening therethrough;
a small electrical fan mounted to the container sidewall in the opening, such that when the fan is powered it draws air into the container;
a plurality of corrugated, extendable and retractable tubes coupled to the lid such that they each fluidly communicate with the interior of the container; and
a plurality of removable caps that are constructed and arranged to be selectively applied over the ends of tubes;
wherein the tubes are constructed and arranged to be placed into items of clothing such as footwear and gloves, so that when the fan is energized air will be directed through one or more of the tubes into such item of clothing, to dry the item.

9. A method of drying articles of clothing, comprising:
providing an empty bucket with a lid, the bucket having a sidewall with an opening therethrough, and a small electrical fan mounted to the container sidewall in the opening, such that when the fan is powered it draws air into the container, and a plurality of corrugated, extendable and retractable tubes coupled to the lid such that they each fluidly communicate with the interior of the container, and a plurality of removable caps that are constructed and arranged to be selectively applied over the ends of tubes;
selecting a number of tubes equal to the number of articles of clothing to be dried;
removing the caps from the selected tubes;
extending the selected tubes from the container and placing the open end of each tube into or near an article of clothing; and then energizing the fan so as to force air through the tubes and into or on the articles of clothing, until the articles of clothing are sufficiently dried.
